(19) United States
(12) Patent Application Publication
(10) Pub. No.: US 2014/0375816 A1
(43) Pub. Date: Dec. 25, 2014

(54) Vehicle Display Device with Movement Compensation

(71) Applicant: Daimler AG, Stuttgart (DE)

(72) Inventor: Christian Maihoefer, Iggingen (DE)

(21) Appl. No.: 14/376,252

(22) PCT Filed: Dec. 12, 2012
(86) PCT No.: PCT/EP2012/005132

§ 371 Date: Aug. 1, 2014

(30) Foreign Application Priority Data
Feb. 2, 2012 (DE) 10 2012 001 950.5

(51) Int. Cl. G06T 19/00; H04N 5/74; G06T 3/60; H04N 7/18

(52) U.S. Cl. CPC G06T 19/006; H04N 7/183; H04N 5/74; G06T 3/60; G06T 2207/20004; G06T 2207/30268; G06T 2215/16
USPC 348/148

(57) ABSTRACT

A method for operating a camera assembly for a vehicle involves displaying at least one image information item on a surface. In response to a proper motion of the surface, the at least one image information item is changed in such a way that the proper motion of the surface is at least largely compensated for. To this end, at least two sequential images are captured by a camera of the camera assembly. At least one reference object that is present in both sequential images is identified. The at least one image information item is fixed in relation to the at least one reference object during the proper motion of the surface.

### CROSS-REFERENCE TO RELATED APPLICATIONS

The present application is related to PCT International Application PCT/EP2012/005131, filed Dec. 12, 2012, a U.S. national stage of which is U.S. ______ (Attorney Docket No. 095309.66827US).

### BACKGROUND AND SUMMARY OF THE INVENTION

Exemplary embodiments of the present invention relate to a method for operating a camera assembly for a vehicle, in which at least one image information item is displayed on a surface. In response to a proper motion of the surface, the at least one information item is changed in such a way that the proper motion of the surface is at least largely compensated for. Exemplary embodiments of the present invention further relate to a camera assembly.

German patent document DE 10 2009 045 169 A1 describes a display device for a vehicle with an image generator for generating an image, and with imaging optics for projecting the image onto a windshield of the vehicle. A camera detects a head position or viewing direction of a driver. Upon detection of a head movement or change in the viewing direction of the driver, an evaluation device is used to change the position of image objects such as directional arrows in such a way that the image objects appear to coincide in a contact-analog manner with real objects in the driver's field of vision. If the vehicle makes a pitching motion, the windshield moves similarly. Upon detection of such a proper motion of the windshield (i.e., the projection surface), a compensation device changes the position of the image objects in such a way that the proper motion of the vehicle is compensated for.

A head-up display used to display graphic information for navigating a vehicle is also disclosed in U.S. patent document US 2010/0292886 A1.

Image information items displayed on a surface such as a vehicle windshield or on a screen or display are also known as augmented reality. Images or videos are supplemented with computer-generated additional information as inserts or overlays.

In prior art applications of augmented reality, which is used primarily as a navigation aid, the insertion of instructions in the right place of the surface is carried out in a comparatively precise and effective manner. However, the ability to compensate for proper motions of the surface has been unsatisfactory thus far. Hence an image information item such as a directional arrow does not appear to adhere statically to a position, but skips. This significantly impairs the usefulness of augmented reality.

Exemplary embodiments of the present invention are directed to a method of the aforementioned type and also a camera assembly that will enable a particularly large compensation of the proper motion in a simple and expedient manner.

In the method of the invention, at least two successive images are captured by a camera of the camera assembly. At least one reference object that is present in both successively captured images is identified. The at least one image information item is fixed in relation to the at least one reference object during the proper motion of the surface. The basis for this is that pixel blocks representing the same image content are easily located by computational means. If the image information item displayed on the surface is displayed on the surface in such a way that it is fixed in relation to such pixel blocks or reference objects, then an undesired motion, for instance a skipping of this image information item, is easily and reliably prevented. A particularly large compensation of the proper motion of the surface is thus achievable in a simple manner. Because the image information item can be clearly associated in keeping with its intended purpose, the information item is particularly utilizable for a user of the camera assembly. The operation of the camera assembly is thus rendered particularly convenient, simple, and useful.

Due to the fact that the image information item is displayed in the same position in relation to the reference object during the proper motion of the surface, comparatively rapid proper motions of the surface can be compensated for, whereas slower motions of an object comprising the camera assembly, especially of a vehicle, will not result in the image information item remaining stationary.

If, according to an advantageous embodiment, a plurality of reference objects that are stationary in relation to one another in the successively captured images is identified, it is then particularly simple to ensure that the at least one image information item is not moved along with a moving reference object.

In another advantageous embodiment of the invention, the at least one image information item is projected onto a surface configured as a vehicle windshield. In such a presentation of the image information, the latter is inserted in the real-world environment by means of a head-up display. In particular a pitching and/or a rolling and/or a yawing of the vehicle are compensated for as proper motions. With these motions of the vehicle about its transverse axis, its longitudinal axis, and/or about the vertical axis, the windshield of the vehicle, i.e., the surface onto which the image information is projected, likewise inevitably executes a pitching, rolling, or yawing motion. In this case the fixation of the image information in relation to the reference object ensures that, for example, the pitching motion of the vehicle does not have any disturbing effects on the display of the image information for the viewer. Operating the vehicle is thus made easier, and errors in the operation of the same can be avoided in a particularly effective manner.

The at least one image information item can also be shown on a surface configured as a display or screen, wherein a movement of the display or the screen is compensated for as a proper motion. This is advantageous if, for example, a user of the camera assembly aims the camera at a component of the vehicle and text information explaining this component and/or symbols delimiting this component is/are shown on the display of the camera. If, for instance, the user of the camera assembly does not keep the camera sufficiently still, and this leads to a movement (e.g., a quivering) of the display, the image information associated with the vehicle component will still remain fixed on the intended location for the information.

However, the display can also be arranged stationarily in relation to the vehicle and can then move with the vehicle. In such a case, the motion of the display is also compensated for by the method described herein.

Particularly with use of the at least one image information item in the vehicle, for the simple and safe operation of the same it is advantageous if a proper motion of the vehicle does not lead to a disturbing motion of the image information item.

For compensating the proper motion of the surface, the at least one image information item can be shifted in a vertical direction and/or in a transverse direction of the surface. If the surface is arranged in the vehicle, it is thus possible to compensate for pitching and/or yawing motions of the vehicle in a particularly effective manner.

It has also proven to be advantageous if, for compensating the proper motion of the surface, the at least one image information item is enlarged and/or reduced, at least in regions. Especially by reducing the size of the image information item, the perceptibility of a motion of the same can likewise be reduced in a particularly effective manner. By the enlargement or reduction of the at least one image information item, at least in regions, it is possible to display the latter distorted in such a way that a change in the viewing angle of an observer of the surface can be accounted for. This applies in particular if this change in the viewing angle is induced by the proper motion of the vehicle.

If as in another advantageous embodiment of the invention the at least one image information item is rotated in order to compensate for the proper motion of the surface, then especially effective compensation of rolling motions of the vehicle is possible if the surface is arranged in a vehicle.

It has also proven to be advantageous if the at least one image information item is masked in order to compensate for the proper motion of the surface. This ensures that the displaying of image information will not result in a user of the camera assembly getting information that is subject to incorrect interpretation or ambiguous.

Lastly, it has proven to be advantageous if an element facilitating the navigation of the vehicle is displayed as at least one image information item. The information item then assists a driver in the operation of the vehicle in a particularly obvious manner. For example, an arrow can indicate that the vehicle should turn at a specific point in the environment. If such an arrow also moves due to the proper motion of the vehicle, in other words the proper motion of the vehicle is not compensated for, it can then be difficult to associate the arrow clearly with the actual turning point. As a result the driver may slow down and obstruct traffic or turn at the wrong point. The method of motion compensation described herein will prevent this from happening.

As image information that facilitates the navigation of the vehicle, however, a line such as a trajectory or lane marking can also be displayed on the surface and thus facilitate the safe navigation of the vehicle.

The camera assembly for a vehicle of the invention comprises an image generator for displaying at least one image information item on a surface, and a compensation device configured for compensating, at least largely, a proper motion of the surface. The compensation device can be used to alter the least one image information item in response to the proper motion of the surface. The camera assembly comprises a camera, which is used to capture at least two successive images. An evaluation device of the camera assembly is used to identify at least one reference object that is present in both successive images. The compensation device is used to fix the at least one image information item in relation to the at least one reference object during the proper motion of the surface. Such a camera assembly enables an especially large compensation of the proper motion in a simple and expedient manner.

The advantages and preferred embodiments described for the method of the invention likewise apply to the camera assembly of the invention.

The features and feature combinations mentioned in the present description as well as the features and feature combinations mentioned in the following description of the figures and/or the features and feature combinations shown in just the figures can not only be used in each of the combinations given, but also in other combinations or individually, without exceeding the scope of the invention.

### BRIEF DESCRIPTION OF THE DRAWING FIGURES

Other advantages, features, and details of the invention will emerge from the claims, the following description of preferred embodiments, and with reference to the figures. Shown are:

FIG. 1 a turn arrow inserted by means of a head-up display in a real-world environment of a vehicle and a reference object, detected by a camera, in the vehicle environment; and

FIG. 2 another view frame of the vehicle environment and how it adjusts itself in response to a pitching motion of the vehicle, wherein the turn arrow remains inserted at its intended position owing to the fixing of said turn arrow in relation to the reference object.

### DETAILED DESCRIPTION

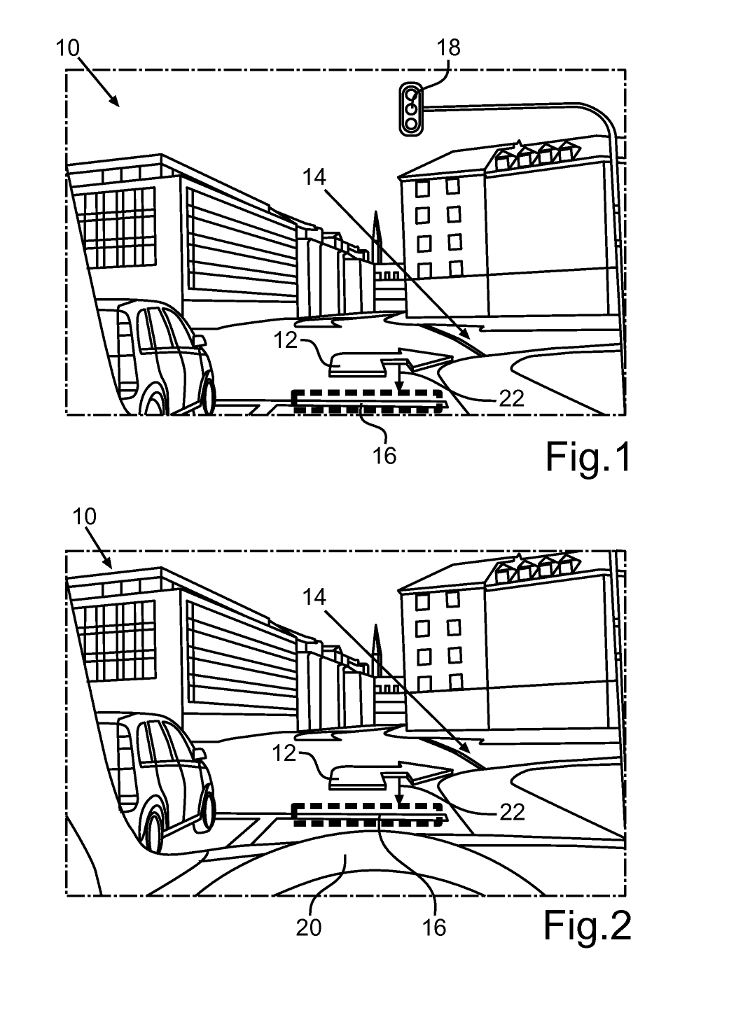

FIG. 1 shows a vehicle environment 10, as it looks through a vehicle windshield in the field of vision of a driver (not shown) of the vehicle. As an example of an artificially generated image information item, a turn arrow 12 is inserted in the vehicle environment 10. This happens because an image generator of a head-up display projects the turn arrow 12 onto the windshield of the vehicle. The turn arrow indicates that one should turn at an intersection 14, and it is shown as an example of an image information item that facilitates the navigation of the vehicle. Such image information items projected into the vehicle environment 10 by means of, e.g., insertion in the driver's field of vision are also known as augmented reality.

It is possible that due to braking the vehicle may execute a pitching motion, in other words a rotary motion about its transverse axis. If the turn arrow 12 in such a case were to remain in the same position as in the view frame of the projection surface shown in FIG. 1, then it would move with the projection surface. The turn arrow 12 would then no longer be at the level of the intersection 14, and the driver would have difficulty in associating the turn arrow 12 clearly with the desired turning point.

To prevent this from happening, a camera assembly of the vehicle, which comprises the image generator for displaying the turn arrow 12, has a compensation device capable of compensating for the proper motion of the vehicle. Thus, the position of the turn arrow 12 is changed in response to the proper motion of the vehicle. To this end, a camera of the camera assembly of the vehicle captures images in succession. An evaluation device of the camera assembly is configured to identify a reference object in these successive images that is present in each of the successive images. To this end, a search for identical image units is carried out in the images captured by the camera. In the present case, a stop line 16 that is present in both the image of FIG. 1 and the image of FIG. 2 is identified as an example of such a reference object.

In the image of FIG. 2, for example, a traffic light 18 shown in the image of FIG. 1 is no longer visible because of the pitching motion of the vehicle. However, a top portion of a steering wheel 20 of the vehicle lies in the field of vision of the observer looking at the windshield. If the turn arrow 12 were inserted at the same absolute position as in the image shown in FIG. 1, it would then be approximately at the level of the steering wheel 20.

In the present case, however, the turn arrow 12 is fixed in relation to the unchanged reference object in successive images, specifically the stop line 16. As a result the turn arrow 12 will still be displayed at the level of the intersection 14 where the vehicle is supposed to turn. Hence not only is the augmented reality in the form of the turn arrow 12 especially well sustained, but also provision is made such that the observer can clearly associate the turn arrow 12 with the intersection 14. This facilitates the operation of the vehicle in that, for example, making a wrong turn can be avoided.

To this end the evaluator, which in the present case identified a static reference object (namely the stop line 16) as a reference point for the turn arrow 12, can also use image contents that change their position from one image to the next. In particular, further provision can be made such that the turn arrow 12 is fixed with reference to a plurality of reference objects, which are themselves stationary in relation to one another in the successively captured images.

The stop line 16, which was recognized on the basis of an algorithm for motion compensation or motion correction in the successively captured images, changed position in the respective view frame according to FIG. 1 and FIG. 2. Through the recognition of the stop line 16, however, provision is made of a fixed reference point and the turn arrow 12 can thus be sketched in at the same position in relation to the stop line 16.

In the case of the head-up display, the stop line 16 on the road is identified as a reference object via the analysis of a real-world image visible through the windshield. This reference object located outside the vehicle is used for the positional orientation of the image information item (i.e., the positional orientation of the turn arrow 12 in the example), which is projected onto the windshield and thus overlaid on the real-world image. The position of the image information item (i.e., of the turn arrow 12 in the example) projected onto the windshield is then continuously adjusted in response to the position of the projection surface (i.e., the windshield) to the reference object. A defined overlay accuracy of the projected image information item with the real-word image is thus ensured.

The type of motion compensation described in the present case is also achievable if the turn arrow 12 or similar image information is not projected onto the vehicle windshield, but mixed with, in other words overlaid on, an image captured by a camera. In particular it is possible to duplicate such a real-world image of the camera on a display, for example a central display of the vehicle.

In order to fix the turn arrow 12 in relation to the stop line 16, a distance 22 between these two objects can be determined and then maintained, even in the event of a pitching motion of the vehicle and consequently also of the projection surface.

The camera assembly is in particular employable in the field of vehicle applications comprising, e.g., navigation, telephone, audio and video sources, including the connection thereof to communication systems and the use thereof for other vehicle applications.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for operating a camera assembly for a vehicle, the method comprising:
displaying at least one image information item is displayed on a surface of the vehicle; and
changing the display of the at least one image information item in response to a proper motion of the surface in such a way that the proper motion of the surface is at least largely compensated for by
capturing, by a camera of the camera assembly, at least two successive images;
identifying at least one reference object that is present in both successive images; and
fixing a display of the at least one image information item in relation to the at least one reference object during the proper motion of the surface.

12. The method of claim 11, wherein a plurality of reference objects are identified, wherein the plurality of objects are stationary in relation to one another in the successively captured images.

13. The method of claim 11, wherein the surface is a windshield of the vehicle, and wherein a pitching, rolling, or yawing of the vehicle is compensated for as the proper motion.

14. The method of claim 11, wherein the surface is a display of the vehicle, and wherein a motion of the display is compensated for as the proper motion.

15. The method of claim 11, wherein the at least one image information item is shifted in a vertical direction or in a transverse direction of the surface to compensate for the proper motion of the surface.

16. The method of claim 11, wherein the at least one image information item is enlarged or reduced, at least in regions, in order to compensate for the proper motion of the surface.

17. The method of claim 11, wherein the at least one image information item is rotated in order to compensate for the proper motion of the surface.

18. The method of claim 11, the at least one image information item is masked in order to compensate for the proper motion of the surface.

19. The method of claim 11, wherein an arrow or a line that facilitates navigation of the vehicle is displayed as the at least one image information item.

20. A camera assembly for a vehicle, comprising:
an image generator configured to display at least one image information item on a surface;
a compensation device configured for at least largely compensating a proper motion of the surface, wherein the compensation device is configured to change a display of the at least one image information item in response to the proper motion of the surface;
a camera configured to capture at least two successive images; and
an evaluation device configured to identify at least one reference object that is present in both successive images,
wherein the compensation device is configured to fix the at least one image information item in relation to the at least one reference object during the proper motion of the surface.
